(19) United States
(12) Patent Application Publication
(10) Pub. No.: US 2011/0309768 A1
(43) Pub. Date: Dec. 22, 2011

(54) TEXTILE WITH PATTERN-LIGHTING EFFECT

(76) Inventors: CHI-TSUNG PENG, Taipei (TW); Chien-Tang Wang, Taipei (TW)

(21) Appl. No.: 12/821,113

(22) Filed: Jun. 22, 2010

(51) Int. Cl. H05B 41/36; G02B 6/04; F21V 3/04

(52) U.S. Cl. 315/291; 362/311.01; 362/554

(57) ABSTRACT

A textile includes a plurality of opaque filaments, a plurality of transparent and light-guiding filaments and a lighting module. The opaque filaments are spaced from each other in a first direction, and the transparent and light-guiding filaments are spaced from each other in a second direction. The opaque filaments and the transparent and light-guiding filaments are woven as a textile. The transparent and light-guiding filaments selectively have a light-dispersion dot formed by a laser-engraving method and the light-dispersion dots are constructed as a predetermined pattern portion. The lighting module is disposed on ends of the transparent and light-guiding filaments. The light-dispersion dots have uniform structure so as to form a uniform lighted area.

### BACKGROUND OF THE INVENTION

1. Field of the Invention

The present invention is a textile with pattern-lighting effect; especially, the present invention relates to a textile of weaving the opaque filaments and the transparent and light-guiding filaments, and the transparent and light-guiding filaments having light-dispersion dot thereon so as to light the pattern on the textile.

2. Description of Related Art

Textiles, such as woven band, woven cloth, woven of fibers, and are widely used in life because of its durability and the high strength; for example, cervical collars and carrying band for pets, shoelaces or decorating bands on clothes.

Traditional textile has lighting mechanism thereon. Light source provides light on clothes to show the reflection area or the images. However, the fibers of the textile have pressing points thereon which are formed by pressing process. The pressing points are arranged as a pattern or a word. When light projects on the pressing points, the pattern or the word is lighted.

In the above-mentioned structure, the sizes of pressing points are not uniformed because the pressure of the pressing process is hard to control. As a result, the lighted pattern does not have uniform lighting property, for example, the brightness of the pattern is not uniform.

Therefore, the traditional lighting textile has disadvantage in product structure.

Consequently, with regard to the resolution of defects illustrated hereinbefore, the inventors of the present invention propose a reasonably designed solution for effectively eliminating such defects.

### SUMMARY OF THE INVENTION

The objective of the present invention is to provide a textile with pattern-lighting effect. The transparent and light-guiding filaments have light-dispersion dot thereon and the light-dispersion dots can be arranged to form a pseudo image/pattern. Therefore, when light is guided along the transparent and light-guiding filaments, the light-dispersion dots can disperse light to show the lighted pseudo image/pattern. The light-dispersion dots have uniform structure so as to form a uniform lighted area. In other words, the lighting performance of the textile is improved.

To achieve the objective described as above, the present invention discloses a textile includes a plurality of opaque filaments, a plurality of transparent and light-guiding filaments and a lighting module.

The opaque filaments are spaced from each other in a first direction, and the transparent and light-guiding filaments are spaced from each other in a second direction. The opaque filaments and the transparent and light-guiding filaments are woven as a textile. The transparent and light-guiding filaments selectively have a light-dispersion dot formed by a laser-engraving method and the light-dispersion dots are constructed as a predetermined pattern portion. On the other hand, the lighting module is disposed on ends of the transparent and light-guiding filaments.

Accordingly, when the light generated by the lighting module propagates through the transparent and light-guiding filaments, the pattern portion is lighted so as to show the pseudo image/pattern.

The present invention provides the following beneficial effects: the opaque filaments and the transparent and light-guiding filaments are woven as a textile, and the light-dispersion dots formed on the transparent and light-guiding filaments can be constructed as the pattern portion. The lighting module provides light in the transparent and light-guiding filaments, and simultaneously the pattern portion is lighted. In addition, the light-dispersion dots have uniform structure so as to form a uniform lighted area of the pattern portion. In other words, the lighting performance of the textile is improved.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1 is a diagram of the textile without the lighted pattern portion according to the present invention;

FIG. 2 is a diagram of the textile with the lighted pattern portion according to the present invention;

FIG. 3 shows the “Z” portion in FIG. 2;

FIG. 4 is a diagram of the textile worn on the wrist of user according to the present invention;

FIG. 5 is a diagram of the textile combined with clothes according to the present invention.

### DETAILED DESCRIPTION OF THE PREFERRED EMBODIMENTS

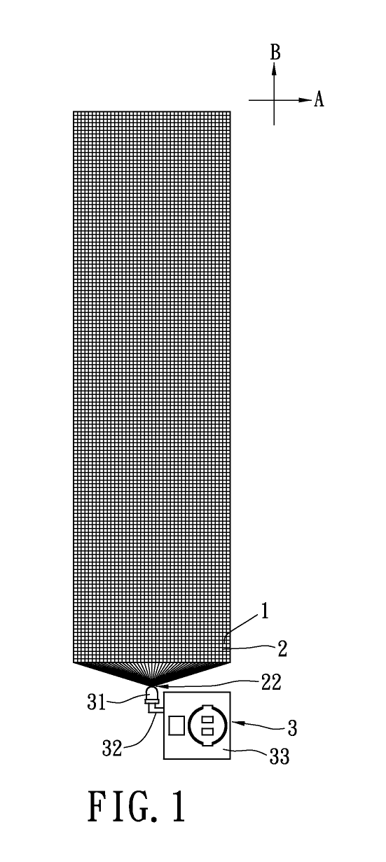

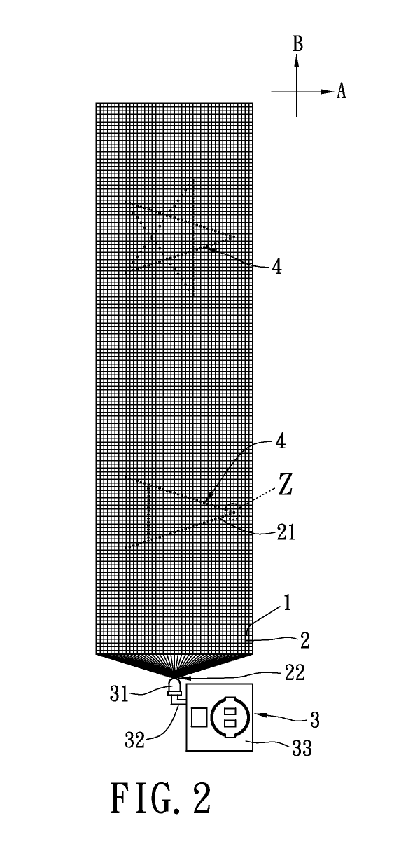

Refer now to FIGS. 1 to 3; the present invention provides a textile with pattern-lighting effect. The textile includes a plurality of opaque filaments 1, a plurality of transparent and light-guiding filaments 2 and a lighting module 3.

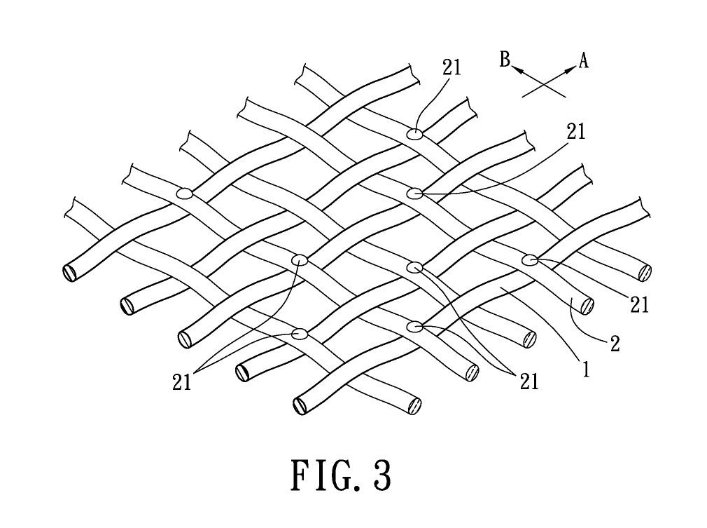

The opaque filaments 1 are spaced from each other in a first direction “A” and the transparent and light-guiding filaments 2 are spaced from each other in another direction, i.e., the second direction “B”. Furthermore, the opaque filaments 1 and the transparent/translucent and light-guiding filaments 2 are woven as a textile, as shown in FIG. 3. In the embodiment, the first direction “A” represents the longitudinal direction of the textile and the second direction “B” represents the transverse direction of the textile. Alternatively, the first direction “A” can be the transverse direction of the textile and the second direction “B” can be the longitudinal direction of the textile. In other words, the woven directions of the opaque filaments 1 and the transparent and light-guiding filaments 2 can be adjusted depending on the size of the textile. For example, the first wrap direction “A” represents the longitudinal direction of the textile and the second wrap direction “B” represents the transverse direction of the textile when the textile is a woven band, and the first direction “A” represents the transverse direction of the textile and the second direction “B” represents the longitudinal direction of the textile when the textile is a woven cloth.

The opaque fabric 1 can be chemically derived fiber or any non-transparent fiber, and the transparent and light-guiding fabric 2 can be light-guiding fiber or any fiber with flexible, transparent, and light-guiding properties. In the embodiment, the transparent and light-guiding fabric 2 is made of transparent thermoplastic material, for example, Polycarbonate, Polystyrene, Polymethyl Methacrylate, MMA Styrene Copolymer, Thermoplastic Polyurethane, and Ethylene Vinyl Acetate, but not limited thereby.

On the other hand, the transparent and light-guiding filaments 2 selectively have a light-dispersion dot 21 formed by a laser-engraving method. The formed light-dispersion dots 21 can be constructed as a predetermined pattern portion 4. The pattern portion 4 can be formed in a predetermined position of the textile and there can be one or two or more patters 4 formed on the textile. Moreover, the pattern portion 4 can be word(s), special pattern(s) or the combination of word and pattern, for example, combination of Chinese word(s) and English word(s), word(s) and personage pattern, and so on.

The forming method of the light-dispersion dots 21 is introduced as following. After weaving the opaque filaments 1 and the transparent and light-guiding filaments 2, laser beam is used to focus on the predetermined positions of the transparent and light-guiding filaments 2. Therefore, the light-dispersion dots 21 are formed on the transparent and light-guiding filaments 2 and the light-dispersion dots 21 can be used for dispersing light radiating along the transparent and light-guiding filaments 2. Because of the high precision of laser, the light-dispersion dots 21 are formed with uniform structure.

The lighting module 3 is disposed on ends of the transparent and light-guiding filaments 2. The lighting module 3 includes a lighting unit 31 for generating the light, a light-conductive fiber 32 and a controlling unit 33. The light-conductive fiber 32 is connected between the lighting unit 31 and the controlling unit 33 so that the controlling unit 33 can be used to control the lighting unit 31. Furthermore, the ends of the transparent and light-guiding filaments 2 are collected to form at least one light inlet 22. The lighting unit 31 aligns to the light inlet 22 so as to project light to the light inlet 22. In the embodiment, the lighting unit 31 is LED(s).

Accordingly, light of the lighting unit 31 is guided inside the transparent and light-guiding filaments 2 through the light inlet 22. When light projects on the light-dispersion dots 21, the light pass through the light-dispersion dots 21 due to the dispersion effect. Therefore, the pattern portion 4 constructed by the light-dispersion dots 21 can be a lighted area of the textile. In other words, detector can see the lighted area of the pattern portion 4. On the other hand, the controlling unit 33 is used to control the lighting mode of the lighting unit 31, for example, continuous lighting, flicker lighting, or to control the colors of light in order to switch the colors.

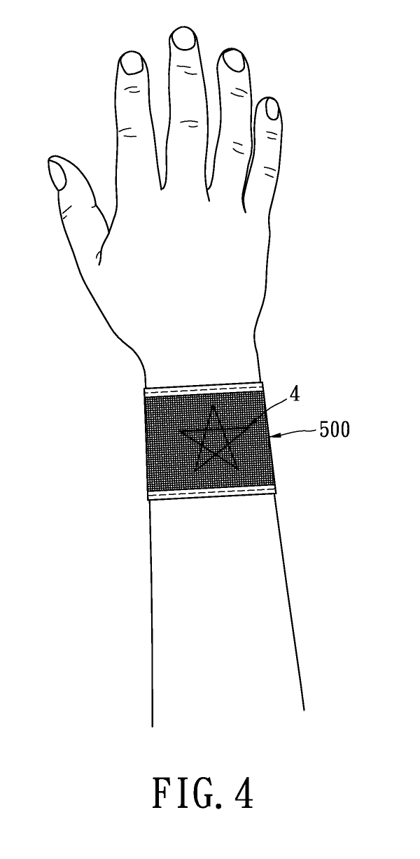

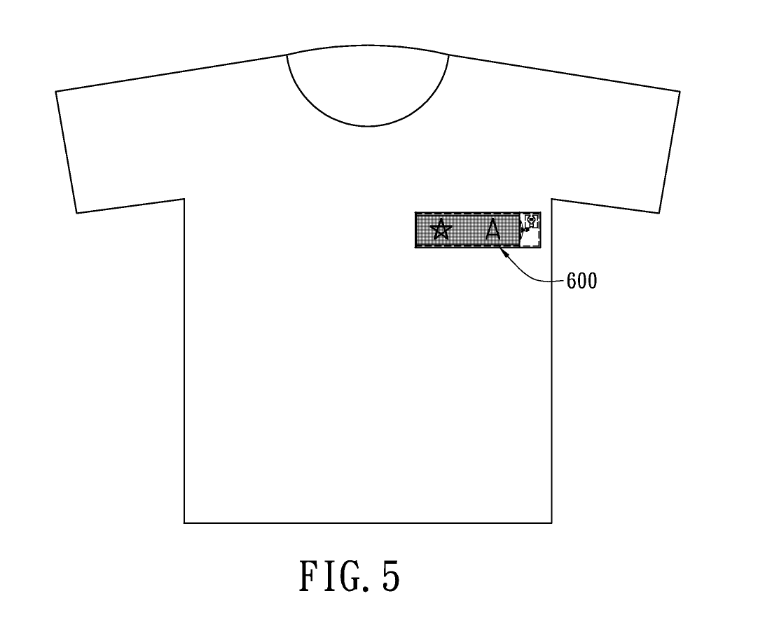

Please refer to FIGS. 4 and 5, the textile of the present invention can be a decoration band 500 which can be worn on the wrist of user, or a decoration band 600 which can be connected on the clothes or shoes. In other words, the textile of the present invention can be used in various applications.

Certainly, the opaque filaments 1 and the transparent and light-guiding filaments 2 are woven together and the light-dispersion dots 21 are formed on the transparent and light-guiding filaments 2. Therefore, when light transmits through the light-dispersion dots 21, the pseudo image which is formed by the arrangement of the light-dispersion dots 21 is shown as lighted area. By the uniform light-dispersion dots 21, the lighted image has uniform brightness.

The texts set forth hereinbefore illustrate simply the preferred embodiments of the present invention, rather than intending to restrict the scope of the present invention claimed to be legally protected thereto. All effectively equivalent changes made by using the contents of the present disclosure and appended drawings thereof are included within the scope of the present invention delineated by the following claims.

What is claimed is:

1. A textile with pattern-lighting effect, comprising:
a plurality of opaque filaments spaced from each other in a first direction;
a plurality of transparent and light-guiding filaments spaced from each other in a second direction, the opaque filaments and the transparent and light-guiding filaments being woven as a textile, the transparent and light-guiding filaments selectively having a light-dispersion dot formed by a laser-engraving, and the light-dispersion dots being constructed as a predetermined pattern portion; and
a lighting module, disposed on ends of the transparent and light-guiding filaments;
wherein the lighting module provides light along the transparent and light-guiding filaments, and the pattern portion constructed by the light-dispersion dots disperses the light for performing a lighting area.

2. The textile with pattern-lighting effect according to claim 1, wherein the transparent and light-guiding filaments are light-guiding fibers.

3. The textile with pattern-lighting effect according to claim 1; wherein the first direction is a longitudinal direction of the textile and the second direction is a transverse direction of the textile, or the first direction is a transverse direction of the textile and the second direction is a longitudinal direction of the textile.

4. The textile with pattern-lighting effect according to claim 1, wherein the lighting module includes a lighting unit generating the light, a light-conductive fiber and a controlling unit, the light-conductive fiber is connected between the lighting unit and the controlling unit, and the controlling unit controls the lighting unit.

5. The textile with pattern-lighting effect according to claim 4, wherein the ends of the transparent and light-guiding filaments are collected to form at least one light inlet, and light of the lighting unit is projected to the light inlet.
